(19) United States
(12) Patent Application Publication
(10) Pub. No.: US 2026/0065281 A1
(43) Pub. Date: Mar. 5, 2026

(54) FRAUD DETECTION FOR TREASURY CHECKS

(71) Applicant: Early Warning Services, LLC, Scottsdale, AZ (US)

(72) Inventors: Tushar Agarwal, Scottsdale, AZ (US); Dhaval Bhatt, Scottsdale, AZ (US); Kathy Carlson, Scottsdale, AZ (US); Syed Badar, Scottsdale, AZ (US); Ganeshkumar Venkatesan, Scottsdale, AZ (US)

(73) Assignee: Early Warning Services, LLC, Scottsdale, AZ (US)

(21) Appl. No.: 18/885,096

(22) Filed: Sep. 13, 2024

Related U.S. Application Data
(60) Provisional application No. 63/689,432, filed on Aug. 30, 2024.

(51) Int. Cl. G06Q 20/40; G06Q 20/04

(52) U.S. Cl. CPC G06Q 20/4016; G06Q 20/042

(57) ABSTRACT

A risk assessment system may include one or more processors and a memory having instructions stored thereon that, when executed by the one or more processors, cause the one or more processors to receive check information associated with a check from a receiving institution. The check information may include a first payee name, a check number, an amount, and a routing number. The instructions further cause the processors to send the check information to an issuing institution. The instructions further cause the processors to receive, from the issuing institution, a second payee name from the issuing institution. The second payee name was printed on the check issued by the issuing institution. The instructions further cause the processors to provide a response to the receiving institution, which may include the second payee name and an indication of whether the first payee name and the second payee name match.

### CROSS-REFERENCE TO RELATED APPLICATIONS

This application claims the benefit of U.S. Provisional Application Ser. No. 63/689,432, filed Aug. 30, 2024, entitled “FRAUD DETECTION FOR TREASURY CHECKS”, the disclosure of which is incorporated by reference herein in its entirety.

### BACKGROUND OF THE INVENTION

Banks have seen an increase in bad actors forging treasury checks issued via check washing, with such fraud being estimated to cost U.S. banks over $300 million in losses per year. To perpetrate fraud, bad actors open a new account with a different bank using real or first party synthetic credentials, wash a stolen check to remove the original payee name, and submit the stolen check with their own real or fictitious name in place of the original payee name. If successful, the funds are withdrawn, leaving the bank with a non-negotiable check. Therefore, improvements in techniques for handling treasury checks to mitigate the risk of fraud associated with check washing are desired.

### BRIEF SUMMARY OF THE INVENTION

A risk assessment system may include one or more processors and a memory having instructions stored thereon that, when executed by the one or more processors, cause the one or more processors to receive check information associated with a check from a receiving institution. The check information may include a first payee name printed on the check, a check number of the check, an amount of the check, and a routing number of the check. The instructions further cause the one or more processors to send at least a portion of the check information to an issuing institution. The instructions further cause the one or more processors to receive, from the issuing institution, a second payee name from the issuing institution. The second payee name was printed on the check issued by the issuing institution. The instructions further cause the one or more processors to provide a response to the receiving institution. The response may include one or both of the second payee name and an indication of whether the first payee name and the second payee name match.

In some embodiments, the instructions may further cause the one or more processors to send a risk score to the receiving institution. The risk score may be indicative of a level of risk associated with a given check having the first payee name on a payee line of the given check. The instructions may further cause the one or more processors to identify a check history associated with the first payee name from one or more bank accounts and generate the risk score based on the check history. A machine learning model may be used to generate the risk score. The machine learning model may be trained using historical information from known fraudulent checks. The risk score may be provided to the receiving institution with the response. The response may include the indication of whether the first payee name and the second payee name match.

Some embodiments of the present technology may encompass methods of assessing risk. The methods may include receiving, by a risk assessment system, check information associated with a check from a receiving institution. The check information may include a first payee name printed on the check, a check number of the check, an amount of the check, and a routing number of the check. The methods may include sending, by the risk assessment system, at least a portion of the check information to an issuing institution. The methods may include receiving, by the risk assessment system and from the issuing institution, a second payee name from the issuing institution. The second payee name was printed on the check issued by the issuing institution. The methods may include providing, by the risk assessment system, a response to the receiving institution. The response may include one or both of the second payee name and an indication of whether the first payee name and the second payee name match.

In some embodiments, the receiving institution may include a first receiving institution. The methods may include determining that the check is fraudulent based on the first payee name and the second payee name being different, receiving a check inquiry from a second receiving institution, and providing a risk score to the second receiving institution. The risk score may be based at least in part on determining that the check is fraudulent. The methods may include determining that the check has been previously submitted at another institution and sending an alert to the receiving institution that indicates that the check has been previously submitted at another institution. Determining that the check has been previously submitted at another institution may be based at least in part on one or both of the check number of the check and the routing number of the check. The methods may include alerting at least one other institution that the check has been previously submitted. The methods may include sending a risk score to the receiving institution. The risk score may be indicative of a level of risk associated with a given check having the first payee name on a payee line of the given check. The risk score may be based, at least in part, on whether prior checks having the first payee name on a payee line of each prior check have been deemed to be fraudulent.

Some embodiments of the present technology may encompass non-transitory computer-readable mediums. The mediums may have instructions stored thereon that, when executed by one or more processors, cause the one or more processors to receive check information associated with a check from a receiving institution. The check information may include a first payee name printed on the check, a check number of the check, an amount of the check, and a routing number of the check. The instructions may further cause the one or more processors to send at least a portion of the check information to an issuing institution. The instructions may further cause the one or more processors to receive, from the issuing institution, a second payee name from the issuing institution. The second payee name was printed on the check issued by the issuing institution. The instructions may further cause the one or more processors to provide a response to the receiving institution. The response may include one or both of the second payee name and an indication of whether the first payee name and the second payee name match.

In some embodiments, the instructions may further cause the one or more processors to send a risk score to the receiving institution. The risk score may be indicative of a level of risk associated with a given check having the first payee name on a payee line of the given check. The risk score may be based, at least in part, on whether the first payee name is associated with a prior fraudulent treasury check. The risk score may be further indicative that the first payee name has been associated with passing a bad check. The check may be a treasury check issued by the U.S. Treasury. The check may be a treasury check issued by a state treasury.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a system for performing a check acceptance process in accordance with the present invention.

FIG. 2 is a swimlane diagram of a process for performing a check acceptance process in accordance with the present invention.

FIG. 3 is a block diagram of a computer system in accordance with the present invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to systems and methods for reducing the risk to financial institutions at which negotiable instruments, such as treasury checks, are redeemed for cash or deposit. In particular, embodiments of the present invention provide solutions that operate by supplying the receiving financial institution with an indication of whether the payee name shown on the redeemed negotiable instrument matches an original payee name printed on the check by the issuing institution (which may be a treasury department in some embodiments). In some instances, the indication may include the original payee name, an indication of whether the payee names match, or both. Based on this information, the receiving financial institution may better determine whether the redeemed negotiable instrument is authentic or fraudulent in nature when determining whether to fund the individual who is redeeming the negotiable instrument. In some embodiments, to further improve the receiving institution's ability to assess the risk associated with a particular negotiable instrument, a risk score may be provided to the receiving financial institution. The risk score may be indicative of a level of risk associated with the negotiable instrument and/or with a payee listed on the negotiable instrument. By enabling the comparison of the original payee name and the payee name on the presented negotiable instrument, embodiments of the present invention may help significantly reduce Treasury Check payee name fraud, which may help reduce certain fraud-attributed losses by up to $300 million per year. Such solutions are not practically possible via human-only and/or conventional computerized systems, as the pre-established access to the treasury records and real-time or near real-time ability of the present invention is essential to the ability of depositing banks to determine whether the treasury check is authentic prior to accepting the check for deposit or cash redemption.

In some embodiments, records of fraudulent negotiable instruments may be maintained and used to assess whether a given check has been previously redeemed and/or whether a redeeming payee has been associated with fraudulent checks. This information may be used to help generate the risk scores and/or otherwise alert one or more financial institutions of potential risks during future redemption attempts involving a given check and/or payee. While discussed primarily in terms of treasury checks, it will be appreciated that the systems and methods described herein may be equally applicable to other forms of negotiable instruments.

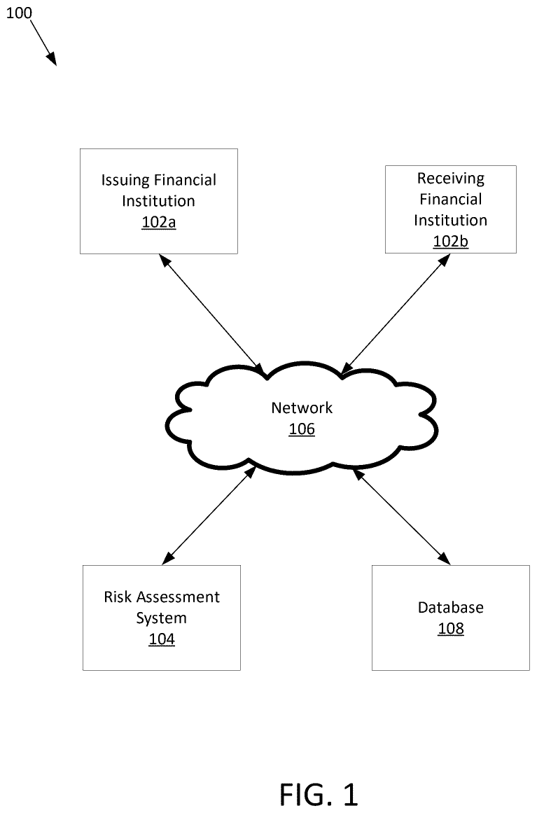

Turning now to FIG. 1, a system 100 for performing risk assessment for negotiable instruments is illustrated. The system 100 may include a number of financial institutions 102, which may include banks, credit unions, treasury departments, and other entities that issue and/or accept deposits of negotiable instruments for payments such as checks. At least some of the financial institutions 102 may maintain a number of accounts that may send and/or receive funds using checks. As shown here, the financial institutions 102 may include issuing financial institutions 102a (e.g., financial institutions that issue negotiable instruments, such as checks, treasury checks, and the like) and receiving financial institutions 102b (e.g., financial institutions 102 at which a given negotiable instrument is presented for cash and/or deposit). Oftentimes, a single financial institution 102 may operate as an issuing financial institution 102a and a receiving financial institution 102b in a single transaction and/or across distinct transactions. In other embodiments, the issuing financial institution 102a and receiving financial institution 102b may be different or separate financial institutions that operate independently from one another. The receiving financial institution 102b may make a determination of whether to accept or deny the redemption of a given negotiable instrument. This determination may involve assessing the risk of the negotiable instrument being fraudulent as will be discussed in greater detail below.

In a particular embodiment, the issuing financial institution 102a may be a treasury, such as the U.S. Treasury or a state treasury. In such embodiments, the negotiable instrument may be a treasury check that is issued by the respective treasury institution. The treasury institution may maintain records of each issued treasury check, including an account number, routing number, amount, payee name, address, and/or other information associated with a given treasury check. For example, in many instances described herein, the issuing financial institution 102a may be a treasury, while the receiving financial institution 102b may be a private bank or credit union, or other such financial institution.

The system 100 may include a risk assessment system 104, which may be in communication with each of the financial institutions 102, such as via one or more networks 106. In operation, the risk assessment system 104 may receive check information from a receiving financial institution 102b. For example, a payee may present the check for redemption, such as for deposit and/or in exchange for cash, at the receiving financial institution 102b. The receiving financial institution 102b may extract and/or otherwise identify check information from the redeemed check and provide the check information to the risk assessment system 104. The check information may include, without limitation, a payee name printed on the check, a payee address printed on the check, a check number of the check, an amount of the check, a routing number of the check, and/or other information associated with the check. The risk assessment system 104 may communicate all or a portion of the check information, such as the routing number and check number, to the issuing financial institution 102a. The issuing institution 102a may use the received check information to identify the originally issued check and to retrieve the record of the issued check. At least some information from the record of the issued check may be returned to the risk assessment system 104. For example, the original payee name (and possibly other information such as the original amount) from the issued check may be provided to the risk assessment system 104. The risk assessment system 104 may provide a response to the receiving financial institution 102b, with the response enabling the receiving financial institution 102b to determine whether the payee name on the redeemed check matches the original payee name from the record of the issued check maintained by the issuing financial institution 102a. For example, the response may include the original payee name and/or an indication of whether the payee name on the redeemed check and the original payee name match. If the payee names match, the receiving financial institution 102b may decide to accept the check or to evaluate the risk of the check using other risk factors (such as a risk score, etc.). If the payee names do not match, the receiving financial institution 102b may determine that the check is likely fraudulent and may deny the check. In such instances, the receiving financial institution 102b may also report the payee on the check to one or more authorities for investigation into the potential fraudulent check. The receiving financial institution 102b may report the payee as being associated with a fraudulent check to the risk assessment system 104, which may use such information the generation of a risk score and/or to otherwise alert other financial institutions 102 of risk associated with the particular payee. In some embodiments, the risk assessment system 104 may request the payee name on the negotiable instrument presented to the receiving financial institution 102b and match that name to the name associated with the record of the issued negotiable instrument from the issuing financial institution 102a. The risk assessment system 104 may then return the result of that match and/or the risk score of that match to the receiving financial institution 102b. The receiving financial institution 102b can then determine whether or not to pay the negotiable financial instrument based at least in part on the match result and/or risk score of that match.

The response may be sent within a short time from when the risk assessment system 104 received the check information from the receiving financial institution 102b. For example, the response may be provided to the receiving financial institution 102b within 1 minute of receipt of the check information, within 45 seconds of receipt of the check information, within 30 seconds of receipt of the check information, within 15 seconds of receipt of the check information, within 10 seconds of receipt of the check information, within 5 seconds of receipt of the check information, within 3 seconds of receipt of the check information, within 1 second of receipt of the check information, or less. Such timing may provide a near real-time solution that provides the receiving financial institution 102b with the ability to determine whether the check is likely fraudulent due to a payee name mismatch prior to accepting the check, which may help reduce the risk that the receiving financial institution 102b has the liability for the funds of the check if ultimately deemed fraudulent.

The risk assessment system 104 may include or be in communication with one or more databases 108. The databases 108 may include historical account and transaction data associated with the payee (e.g., an account owner) and/or the check number. For example, the databases 108 may include records (e.g., balances, transactions, account ages, average deposit amounts, etc.) of each account managed by the financial institutions 102, along with information about the owner(s) of each account, such as personally identifiable information about each owner. The databases 108 may include information about the check history (e.g., check velocity, amounts, payors, etc.) of each account and/or account owner. To facilitate the population of the databases 108, the risk assessment system 104 may establish relationships with any number of the financial institutions 102. The account and owner data associated with the accounts may be provided to the databases 108 from the financial institutions 102 themselves, in real-time and/or in batch mode. This may enable the risk assessment system 104 to access up to date historical and transaction data for each account and/or account owner and may enable the risk assessment system 104 to determine risk factors and/or risk scores for accounts and/or owners thereof across a large number of financial institutions 102. The risk assessment system 104 may retrieve and/or analyze data associated with a given payee and provide a risk score to the receiving financial institution 102b associated with a given negotiable instrument, as will be discussed in greater detail below. The financial institutions 102 may use these risk scores in determining whether to accept or deny a given check or other negotiable instrument. In some embodiments, the databases 108 may also be used by the risk assessment system 104 to look up whether a given check has already been redeemed, enabling the risk assessment system 104 to alert the receiving financial institution 102b that the check is a duplicate prior to being accepted.

As noted above, the risk assessment system 104 may perform fraud risk scoring and/or other fraud detection and mitigation services in some embodiments. The risk scores may be provided to the receiving financial institution 102b that is associated with a given check. The receiving financial institution 102b may use the risk scores to further assess the risk of fraud associated with the check. In some embodiments, the risk scores may be generated by a human-developed risk model. For example, the risk model may analyze a number of risk factors to generate a risk score associated with checks to or from a given account and/or account owner. In some embodiments, the risk model may assign equal weights to each risk factor, while in other embodiments the risk model may assign one or more of the risk factors with different weights. In some embodiments, the risk factors and/or associated weights may be selected by the risk assessment system 104, while in some embodiments each financial institution 102 may select the risk factors and/or associated weights that they deem important in assessing risk to be utilized in generating the risk score. In some embodiments, the risk factors may include whether prior checks having the payee name on a payee line of the prior check have been deemed to be fraudulent and/or whether the payee name has been associated with a prior fraudulent treasury check. This may enable the risk assessment system 104 to generate risk scores that factor in whether a payee has committed fraud at a different receiving financial institution 102b and/or at a different account. Additionally, or alternatively, the risk factors may include check velocities associated with the payee's various accounts. By utilizing the check velocity and/or other account history of the payee (or other person or entity depositing the checks) across the various financial institutions 102, the risk assessment system 104 can better predict the risk of a future risk of checks from this same payee or entity getting returned because of fraudulent reasons.

In some embodiments, the risk scores may be generated using a machine learning model. For example, the risk assessment system 104 may include a machine learning risk model (such as a Gradient Boosted Trees model) that has been trained to predict the probability that a given check is fraudulent. For example, the risk model may be provided with data from a number of prior fraudulent checks and/or a number of prior valid checks. The risk model may be trained to identify various fraud risk factors (including account, transaction, and/or negotiable instrument characteristics) that may be indicative of fraudulent checks.

For example, a number of checks that are known to be fraudulent and/or checks that are known to be authentic may be provided to the machine learning model as input variables. Each check may include an indication of whether the particular check was fraudulent, along with other transaction and/or other information about the check, a payee name, an account associated with the check (e.g., a destination account), and/or an owner of the account associated with the check. For example, each check may include one or more pieces of information, such as a payment amount, a time and/or date on the check, a date of presentation/deposit of the check, a location of the presentation of the check, a payee name, an address, and/or other data. Additionally, some or all of the checks may include additional information related to the recipient and/or sender (e.g., account owners), such as one or more of the fraud risk factors outlined above. The check information (and possibly the additional information) may be analyzed by the machine learning model in view of the indication of whether each check was authentic or fraudulent, enabling the machine learning model to generate a number of sets of check, payee, and/or account characteristics that are indicative of a high risk of fraud. When a new check is analyzed, the relevant check information may be supplied to the machine learning model, which may identify characteristics associated with the new check to determine whether the new check is likely fraudulent. The use of such a machine learning model to generate the risk scores enables vast amounts of prior check, account, and account owner data to be analyzed to identify various risk factors that are indicative of risk that a given check is fraudulent. The machine learning risk model may be able to analyze a vast quantity of data and identify complex patterns within the data to identify risk factors that are not likely or possible to be identified using human-generated models and may provide greater accuracy in identifying fraudulent checks.

In some embodiments, the risk model may behave deterministically (e.g., an inquiry with the same information scored by the model with the same feature values will always produce the same score). In other embodiments the risk model can be updated/retrained multiple times (e.g., the model can change upon retraining of the model, when the model goes through model governance, and/or when a new version of the model is deployed). For example, the model may be updated/retrained after new checks have been presented for deposit and/or cash redemption at one or more financial institutions. In some embodiments, the risk assessment system 104 may monitor current check scams and other fraudulent activity. For example, the risk assessment system 104 may receive information on fraudulent checks and scams from the various user financial institutions 102 and/or other external sources. The risk assessment system 104 and/or risk model may analyze this information to identify characteristics that are indicative of such fraud. For example, the risk assessment system 104 and/or risk model may be supplied with information from known fraudulent check transactions to identify combinations of different fraud risk factors (such as those described above) that may be indicative of a fraudulent check based on the information on fraudulent checks and scams provided by the various user financial institutions 102 and/or other external sources. The risk assessment system 104 may also maintain and update information and educational resources on the various fraudulent activities that may be used to instruct the financial institutions 102 on how to handle various fraudulent activity. For example, information on what the financial institutions 102 should look for to detect fraudulent checks and/or steps that may be taken to avoid and/or reduce the threat of falling victim to fraud. The risk assessment system 104 may monitor trends in various scams, which may be used to keep information up to date and to best educate the various partner financial institutions 102 of the risk assessment system 104.

In some embodiments, the risk scores may factor in various information, such as whether a treasury check (or other check) has been returned by a financial institution 102, which may indicate possible fraud. For example, if a treasury check with no identified risk indicators is returned by a financial institution 102, a reason for this return may then be a treasury check payee name mismatch. In this case, if the same payee name submits another check within the financial institutions 102 that have established relationships with the risk assessment system 104, there may be an increased probability that the same person is trying to fraudulently submit another check. This information may be used to adjust the risk score to indicate a higher risk of fraud associated with the payee. The risk assessment system 104 may inform other financial institutions 102 if the same payee name submits another check with a different financial institution 102. If a treasury check by a person or entity has been returned in the past, there is an increased chance that the owner of the check has tried to commit fraudulent activity and may do so again when submitting a check elsewhere. If a treasury check by a person or entity has been return in the past, there is an increased probability that the owner of this check has tried to commit a fraudulent activity and may do so again when they submit a check elsewhere. Such behaviors may lead to adjustments in risk scores to flag or otherwise identify the person or entity to better alert other financial institutions 102 of the risk associated with this payee.

The risk scores may be continually updated, in real-time upon the risk assessment system 104 and/or databases 108 receiving new information from one or more of the financial institutions 102 and/or periodically at predetermined intervals (e.g., daily, weekly, monthly, etc.). In some embodiments, the risk scores may be updated after each transaction with one of the financial institutions 102.

As noted above, the financial institutions 102 and the risk assessment system 104, and/or databases 108 may be connected via one or more wired and/or wireless networks 106. Data transmitted across the networks 106 may be secured using encryption techniques, hypertext transfer protocol secure (HTTPS), secure sockets layer (SSL), transport layer security (TLS), and/or other security protocol.

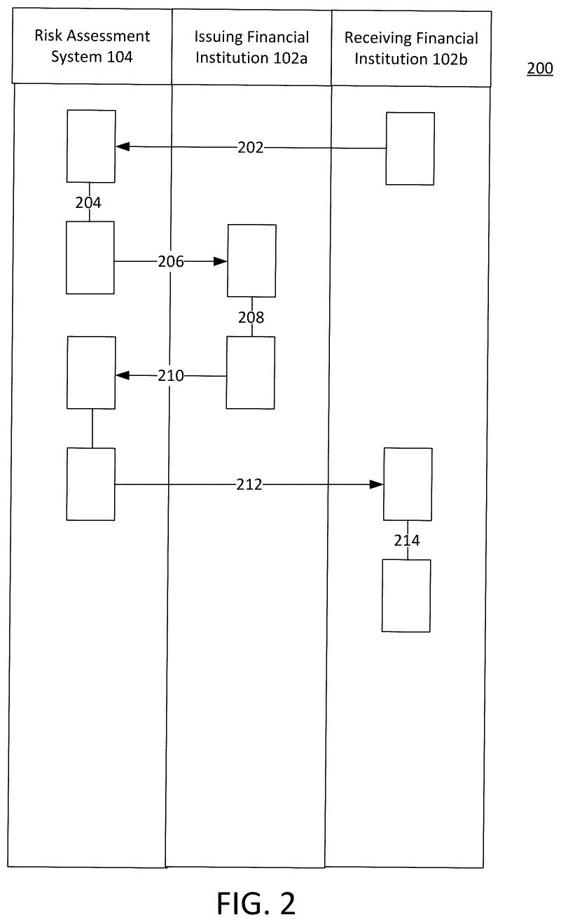

FIG. 2 illustrates a swimlane diagram showing interactions between different entities of system 100 as part of a check acceptance procedure or process 200. The check acceptance process 200 may be initiated by a payee presenting a check, such as a treasury check, to a receiving financial institution 102b in exchange for cash and/or for deposit in a destination account managed by the receiving financial institution 102b. At operation 202, the receiving financial institution 102b (e.g., a financial institution 102 at which the check is presented) may provide check information associated with the check to the risk assessment system 104. The check information may include, without limitation, a payee name printed on the check, an address, a check number of the check, an amount of the check, an account number of the check, and/or a routing number of the check. The check information may be provided by sending an image of the check to the risk assessment system 104 and/or by the receiving financial institution 102b extracting and/or otherwise identifying the check information and sending the extracted check information to the risk assessment system 104. Where an image of the check is provided, the risk assessment system 104 may parse the check information from the image, such as by using optical character recognition processes on the image to identify individual data fields of the check.

The risk assessment system 104 may analyze the check information and identify an issuing financial institution 102a associated with the check at operation 204. For example, the risk assessment system 104 may use the routing number of the check to identify the financial institution 102 that issued the check. Once the issuing financial institution 102a has been identified, the risk assessment system 104 may send at least a portion of the check information to the issuing financial institution 102a at operation 206. For example, the risk assessment system 104 may send enough of the check information for the issuing financial institution 102a to identify the check that is being presented to the receiving financial institution 102b. In some embodiments, this may include sending all of the check information, while in other embodiments only a subset of the check information may be sent to the issuing financial institution 102a. At a minimum, the risk assessment system 104 may send the check number of the presented check to the issuing financial institution 102a. Where the issuing financial institution 102a maintains multiple issuing accounts, the account number of the check may also need to be included in the transmission to the issuing financial institution 102a.

The issuing financial institution 102a may use the check information, and in particular the check number and/or account number, to identify the presented check at operation 208. The issuing financial institution 102a may then determine the original check information that was printed and/or otherwise provided on the check when originally issued by the issuing financial institution 102a. The original check information may include the original payee name and, optionally, additional information such as (but not limited to) an issue date of the check, an amount of the check, and/or other information. At least some of the original check information (including the original payee name) may be sent to the risk assessment system 104 at operation 210.

Based on the original check information, the risk assessment system 104 may provide a response to the receiving financial institution 102b at operation 212. The response may include the original payee name and/or an indication of whether the payee name on the presented check and the original payee name match. The receiving financial institution 102b may use the information from the response as part of a determination of whether to accept or deny the check at operation 214. For example, where the payee name on the presented check does not match the original payee name (either based on the indication or based on the receiving financial institution 102b comparing the received original payee name with the payee name on the presented check), the receiving financial institution 102b may determine that the check is fraudulent and deny the check. Where the payee name on the presented check does match the original payee name, the financial institution 102b may accept the check and/or perform further fraud detection steps (such as analyzing a risk score, reviewing other check data, etc.) prior to making a determination to accept or deny the check. For example, in some embodiments, the receiving financial institution 102b may compare other data from the original check information to corresponding data on the presented check. As just one example, the receiving financial institution 102b may compare the original payment amount with the payment amount shown on the presented check to ensure the payment amount has not been altered prior to accepting or denying the check.

In some embodiments, the risk assessment system 104 may generate and send a risk score to the receiving financial institution 102b. The risk score may be sent with the response in some embodiments. For example, the check information of the check may be provided to a risk model of the risk assessment system 104. In some embodiments, the risk model may be a human-generated risk model in which a number of inputs (e.g., risk factors) associated with the check and/or the payee may be analyzed and/or weighted to produce a risk score. In other embodiments, the risk model may include a machine learning risk model that has been trained to generate risk scores based on the inputs. For example, historical and/or transactional information associated with the payee on the check may be retrieved from the databases 108 and provided to the machine learning risk model. The machine learning risk model may analyze the data and generate a risk score that is indicative of a probability that the check is fraudulent. More specifically, in some embodiments the risk score may be indicative of indicative of a level of risk associated with a given check having the payee name on a payee line of the given check and/or indicative that the payee name has been associated with passing a bad check. The risk score may be supplied to the receiving financial institution 102b.

In a particular embodiment, the risk score may be generated based on a check history associated with one or more accounts of the payee. For example, the risk assessment system 104 may utilize the payee name from the check to identify one or more bank accounts associated with the payee. The bank accounts may be at the receiving financial institution 102b and/or at one or more other financial institutions 102. Once some or all of the payee's accounts have been identified, the risk assessment system 104 may access account data of each account within the databases 108 and analyze the account data to determine various risk factors, such as the check velocity of the payee at one or more of the accounts. This check velocity information may be provided to the risk model and may factor into the risk score.

In some embodiments, upon determining that the check is fraudulent, the receiving financial institution 102b may provide an indication of the determination to the risk assessment system 104. If the risk assessment system 104 receives a subsequent inquiry (e.g., set of check information) from a second receiving financial institution 102b having a same payee name, the risk assessment system 104 may provide the second receiving financial institution 102b with a risk score that is based on at least in part on the indication of the determination that the payee's prior check was fraudulent. In other words, the risk score provided to the second receiving financial institution 102b may be increased or elevated as a result of the previous fraudulent check.

In some embodiments, upon receiving the check information from the receiving financial institution 102b, the risk assessment system 104 may compare at least a portion of the check information to with information stored by databases 108, such as prior known check redemptions and/or attempts to determine whether the check has been previously redeemed. For example, the risk assessment system 104 may compare a routing number, account number, and check number of the check to those of prior known check redemptions and/or attempts and provide the receiving financial institution 102b with an indication of whether the check has been previously presented at another financial institution. For example, if a matching check is located, the risk assessment system 104 may determine that the check is a duplicate and may inform the receiving financial institution 102b of the duplicate status. If no matching check is located, the risk assessment system 104 may determine that the check is not a duplicate and inform the receiving financial institution 102b that no duplicate issues are present. Based on the information from the risk assessment system 104, the receiving financial institution 102b may determine whether to accept or deny the check.

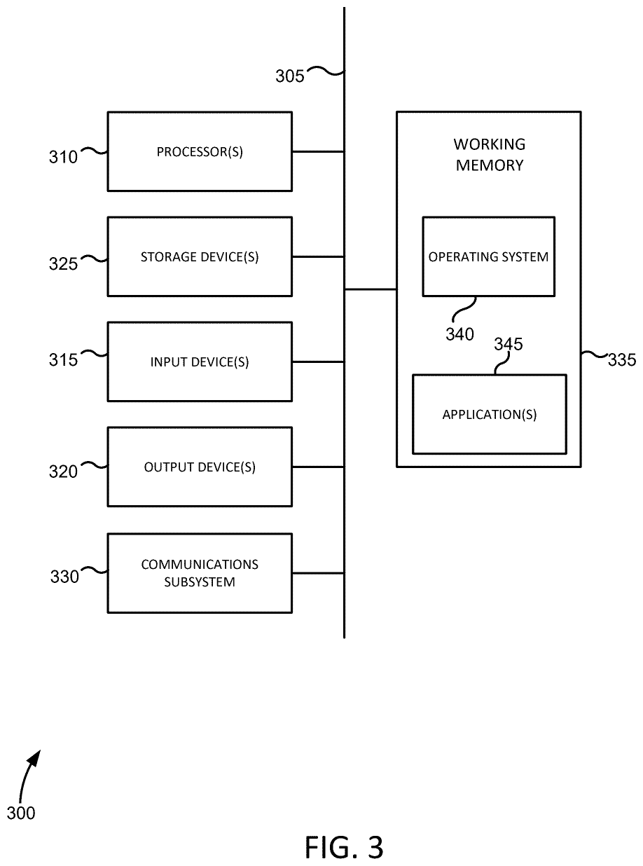

A computer system as illustrated in may be incorporated as part of the previously described computerized devices. For example, computer system 300 can represent some of the components of computing devices, such as the financial institutions 102, risk assessment system 104, databases 108, and/or other computing devices described herein. FIG. 3 provides a schematic illustration of one embodiment of a computer system 300 that can perform the methods provided by various other embodiments, as described herein. FIG. 3 is meant only to provide a generalized illustration of various components, any or all of which may be utilized as appropriate. FIG. 3, therefore, broadly illustrates how individual system elements may be implemented in a relatively separated or relatively more integrated manner.

The computer system 300 is shown comprising hardware elements that can be electrically coupled via a bus 305 (or may otherwise be in communication, as appropriate). The hardware elements may include a processing unit 310, including without limitation one or more processors, such as one or more central processing units (CPUs), graphical processing units (GPUs), special-purpose processors (such as digital signal processing chips, graphics acceleration processors, and/or the like); one or more input devices 315, which can include without limitation a keyboard, a touchscreen, receiver, a motion sensor, a camera, a smartcard reader, a contactless media reader, and/or the like; and one or more output devices 320, which can include without limitation a display device, a speaker, a printer, a writing module, and/or the like.

The computer system 300 may further include (and/or be in communication with) one or more non-transitory storage devices 325, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 300 might also include a communication interface 330, which can include without limitation a modem, a network card (wireless or wired), an infrared communication device, a wireless communication device and/or chipset (such as a Bluetooth™ device, an 502.11 device, a Wi-Fi device, a WiMAX device, an NFC device, cellular communication facilities, etc.), and/or similar communication interfaces. The communication interface 330 may permit data to be exchanged with a network (such as the network described below, to name one example), other computer systems, and/or any other devices described herein. In many embodiments, the computer system 300 will further comprise a non-transitory working memory 335, which can include a RAM or ROM device, as described above.

The computer system 300 also can comprise software elements, shown as being currently located within the working memory 335, including an operating system 340, device drivers, executable libraries, and/or other code, such as one or more application programs 345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 325 described above. In some cases, the storage medium might be incorporated within a computer system, such as computer system 300. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 300 and/or might take the form of source and/or installable code, which, upon compilation and/or installation on the computer system 300 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 310, applications 345, etc.) Further, connection to other computing devices such as network input/output devices may be employed.

Some embodiments may employ a computer system (such as the computer system 300) to perform methods in accordance with the disclosure. For example, some or all of the procedures of the described methods may be performed by the computer system 300 in response to processing unit 310 executing one or more sequences of one or more instructions (which might be incorporated into the operating system 340 and/or other code, such as an application program 345) contained in the working memory 335. Such instructions may be read into the working memory 335 from another computer-readable medium, such as one or more of the storage device(s) 325. Merely by way of example, execution of the sequences of instructions contained in the working memory 335 might cause the processing unit 310 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 300, various computer-readable media might be involved in providing instructions/code to processing unit 310 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 325. Volatile media include, without limitation, dynamic memory, such as the working memory 335. Transmission media include, without limitation, coaxial cables, copper wire, and fiber optics, including the wires that comprise the bus 305, as well as the various components of the communication interface 330 (and/or the media by which the communication interface 330 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 330 (and/or components thereof) generally will receive the signals, and the bus 305 then might carry the signals (and/or the data, instructions, etc. carried by the signals) to the working memory 335, from which the processor(s) 310 retrieves and executes the instructions. The instructions received by the working memory 335 may optionally be stored on a non-transitory storage device 325 either before or after execution by the processing unit 310.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, +5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, +5%, or +0.1% from the specified value, as such variations are appropriate to in the context of the systems, devices, circuits, methods, and other implementations described herein.

As defined herein, real-time, can in some embodiments, be defined with respect to operations carried out as soon as practically possible upon the occurrence of a triggering event. A triggering event can include receipt of data necessary to execute a task or to otherwise process information. Due to delays that are inherent in data transmission and/or in computing speeds, the term real-time encompasses operations that occur in “near” real-time or somewhat delayed from a triggering event. In a number of embodiments, real-time can mean real-time less a time delay for processing (e.g., determining) and/or transmitting data. The particular time delay can vary depending on the type and/or amount of the data, the processing speeds of the hardware, the transmission capability of the communication hardware, the transmission distance, and the like. However, in many embodiments, the time delay can be less than approximately one second, five seconds, ten seconds, thirty seconds, one minute, or five minutes.

As defined herein, batch mode, can in some embodiments, be defined with respect to operations carried out at a scheduled time interval upon the occurrence of a triggering event. A triggering event can include receipt of data necessary to execute a task or to otherwise process information. The particular scheduled time interval can vary depending on the type and/or amount of the data. However, in many embodiments, the scheduled time interval for the batch mode can be less than approximately 30 minutes, 1 hour, 3 hours, 6, hours, 12, hours, or 24 hours.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

1. A risk assessment system, comprising:
one or more processors; and
a memory having instructions stored thereon that, when executed by the one or more processors, cause the one or more processors to:
receive, via one or more communications networks, check information associated with a treasury check from a receiving institution, wherein:
data sent over the one or more communications networks is encrypted;
the check information comprises a first payee name printed on the treasury check, a check number of the treasury check, an amount of the treasury check, and a routing number of the treasury check; and
the receiving institution comprises a financial institution at which the treasury check has been presented for redemption;
identify a treasury department that issued the treasury check using the routing number of the treasury check;
send, via the one or more communications networks, at least a portion of the check information to the treasury department that issued the treasury check;
receive, in response to sending the at least a portion of the check information, via the one or more communication networks, a second payee name from the treasury department, wherein the second payee name was printed on the treasury check issued by the treasury department; and
provide, via the one or more communications networks, a response to the receiving institution, the response comprising one or both of the second payee name and an indication of whether the first payee name and the second payee name match, wherein the one or both of the second payee name and the indication of whether the first payee name and the second payee name match are used to determine whether the treasury check is fraudulent.

2. The risk assessment system of claim 1, wherein the instructions further cause the one or more processors to:
send a risk score to the receiving institution, wherein the risk score is indicative of a level of risk associated with a given check having the first payee name on a payee line of the given check.

3. The risk assessment system of claim 2, wherein the instructions further cause the one or more processors to:
identify a check history associated with the first payee name from one or more bank accounts; and
generate the risk score based on the check history.

4. The risk assessment system of claim 2, wherein:
a machine learning model is used to generate the risk score.

5. The risk assessment system of claim 4, wherein:
the machine learning model is trained using historical information from known fraudulent checks.

6. The risk assessment system of claim 2, wherein:
the risk score is provided to the receiving institution with the response.

7. The risk assessment system of claim 1, wherein:
the response comprises the indication of whether the first payee name and the second payee name match.

8. A method of assessing risk, comprising:
receiving, by a risk assessment system via one or more communications networks, check information associated with a treasury check from a receiving institution, wherein:
data sent over the one or more communications networks is encrypted;
the check information comprises a first payee name printed on the treasury check, a check number of the treasury check, an amount of the treasury check, and a routing number of the treasury check; and
the receiving institution comprises a financial institution at which the treasury check has been presented for redemption;
identifying, by the risk assessment system, a treasury department that issued the treasury check using the routing number of the treasury check;
sending, by the risk assessment system via the one or more communications networks, at least a portion of the check information to the treasury department that issued the treasury check;
receiving, by the risk assessment system, in response to sending the at least a portion of the check information, via the one or more communication networks, a second payee name from the treasury department, wherein the second payee name was printed on the treasury check issued by the treasury department; and
providing, by the risk assessment system via the one or more communications networks, a response to the receiving institution, the response comprising one or both of the second payee name and an indication of whether the first payee name and the second payee name match, wherein the one or both of the second payee name and the indication of whether the first payee name and the second payee name match are used to determine whether the treasury check is fraudulent.

9. The method of assessing risk of claim 8, wherein:
the receiving institution comprises a first receiving institution; and
the method comprises:
determining that the treasury check is fraudulent based on the first payee name and the second payee name being different;
receiving a check inquiry from a second receiving institution; and
providing a risk score to the second receiving institution, wherein the risk score is based at least in part on determining that the treasury check is fraudulent.

10. The method of assessing risk of claim 8, further comprising:
determining that the treasury check has been previously submitted at another institution; and
sending an alert to the receiving institution that indicates that the treasury check has been previously submitted at another institution.

11. The method of assessing risk of claim 10, wherein:
determining that the treasury check has been previously submitted at another institution is based at least in part on one or both of the check number of the treasury check and the routing number of the treasury check.

12. The method of assessing risk of claim 10, further comprising:
alerting at least one other institution that the treasury check has been previously submitted.

13. The method of assessing risk of claim 8, further comprising:
sending a risk score to the receiving institution, wherein the risk score is indicative of a level of risk associated with a given check having the first payee name on a payee line of the given check.

14. The method of assessing risk of claim 13, wherein:
the risk score is based, at least in part, on whether prior checks having the first payee name on a payee line of each prior check have been deemed to be fraudulent.

15. A non-transitory computer-readable medium having instructions stored thereon that, when executed by one or more processors, cause the one or more processors to:
receive, via one or more communications networks, check information associated with a treasury check from a receiving institution, wherein:
data sent over the one or more communications networks is encrypted;
the check information comprises a first payee name printed on the treasury check, a check number of the treasury check, an amount of the treasury check, and a routing number of the treasury check; and
the receiving institution comprises a financial institution at which the treasury check has been presented for redemption;
identify a treasury department that issued the treasury check using the routing number of the treasury check;
send, via the one or more communications networks, at least a portion of the check information to a treasury department that issued the treasury check;
receive, in response to sending the at least a portion of the check information, via the one or more communication networks, a second payee name from the treasury department, wherein the second payee name was printed on the treasury check issued by the treasury department; and
provide, via the one or more communications networks, a response to the receiving institution, the response comprising one or both of the second payee name and an indication of whether the first payee name and the second payee name match, wherein the one or both of the second payee name and the indication of whether the first payee name and the second payee name match are used to determine whether the treasury check is fraudulent.

16. The non-transitory computer-readable medium of claim 15, wherein the instructions further cause the one or more processors to:
send a risk score to the receiving institution, wherein the risk score is indicative of a level of risk associated with a given check having the first payee name on a payee line of the given check.

17. The non-transitory computer-readable medium of claim 16, wherein:
the risk score is based, at least in part, on whether the first payee name is associated with a prior fraudulent treasury check.

18. The non-transitory computer-readable medium of claim 16, wherein:
the risk score is further indicative that the first payee name has been associated with passing a bad check.

19. (canceled)

20. (canceled)

21. The risk assessment system of claim 1, wherein:
the response to the receiving institution comprises the second payee name.

22. The risk assessment system of claim 1, wherein:
the response is provided to the receiving institution within 1 minute of receiving the check information.
